(19) United States
(12) Patent Application Publication
(10) Pub. No.: US 2004/0120166 A1
(43) Pub. Date: Jun. 24, 2004

(54) Vsc-converter

(76) Inventor: Bo Bijlenga, Amal (SE)

Correspondence Address: SWIDLER BERLIN SHEREFF FRIEDMAN, LLP, 3000 K STREET, NW, BOX IP, WASHINGTON, DC, 20007, US

(21) Appl. No.: 10/474,782

(22) PCT Filed: Apr. 5, 2002
(86) PCT No.: PCT/SE02/00670

(30) Foreign Application Priority Data
Apr. 11, 2001 (SE) 0101274-9

(51) Int. Cl. H02M 5/45

(52) U.S. Cl. 363/37

(57) ABSTRACT

The invention relates to a VSC-converter for converting high-voltage direct voltage into alternating voltage and vice versa, which comprises a series connection of at least two current valves (2, 3) arranged between two poles (4, 5), a positive and a negative, of a direct voltage side of the converter, each of which current valves comprising a semiconductor element (9) of turn-off type and a rectifying member (10) connected in anti-parallel therewith, an alternating voltage phase line (12) being connected to a midpoint (11), denominated phase output, of the series connection between two current valves while dividing the series connection into two equal parts. According to the invention, the converter is provided with means for limitation of the voltage derivatives in relation to ground in the phase output (11), said means comprising one or several capacitive members (20, 22, 23, 24, 36, 37, 38), through which the phase output (11) is connected to ground, said capacitive member/members (20, 22, 23, 24, 36, 37, 38) being designed with a capacitance that is adapted for preventing undesiredly large voltage derivatives in relation to ground in the phase output (11). The invention also relates to a plant for transmitting electric power through a direct voltage network for high-voltage direct current (HVDC) comprising such a VSC-converter.

### FIELD OF THE INVENTION AND PRIOR ART

The present invention relates to a VSC-converter according to the preamble of the subsequent claim 1. The invention also relates to a plant for transmitting electric power through a direct voltage network for high-voltage direct current (HVDC).

A VSC-converter for connection between a direct voltage network and an alternating voltage network is previously known e.g. from the thesis “PWM and control of two and three level High Power Voltage Source Converters” by Anders Lindberg, Royal Institute of Technology, Stockholm, 1995, in which publication a plant for transmitting electric power through a direct voltage network for high-voltage direct current (HVDC), while utilizing such converters, is described. Before the creation of this thesis, plants for transmitting electric power between a direct voltage network and an alternating voltage network have been based upon the use of network commutated CSC (Current Source Converter)-converters in stations for power transmission. However, in this thesis a totally new concept is described, which is based on instead using VSC (Voltage Source Converter)-converters for forced commutation for transmitting electric power between a direct voltage network being voltage stiff therethrough, in the case in question for high-voltage direct current, and alternating voltage networks connected thereto, which offers several considerable advantages as compared to the use of network commutated CSC-converters in HVDC, among which it may be mentioned that the consumption of active and reactive power may be controlled independently of each other and that there is no risk of commutation faults in the converters and thereby no risk of commutation faults being transmitted between different HVDC-links, as may occur with network commutated CSC:s. Furthermore, it is possible to feed a weak alternating voltage network or a network without any generation of its own (a dead alternating voltage network). There are also further advantages.

The inventional VSC-converter may be included in a plant for transmitting electric power through a direct voltage network for high-voltage direct current (HVDC), in order to e.g. transmit the electric power from the direct voltage network to an alternating voltage network. In this case, the converter has its direct voltage side connected to the direct voltage network and its alternating voltage side connected to the alternating voltage network. The inventional VSC-converter may however also be directly connected to a load, such as a high-voltage generator or motor, in which case the converter has either its direct voltage side or its alternating voltage side connected to the generator/motor. The invention is not limited to these applications; on the contrary the converter may just as well be used for conversion in a SVC (Static Var Compensator) or a Back-to-back station. The voltages on the direct voltage side of the converter are with advantage high, 10-400 kV, preferably 130-400 kV. The inventional converter may also be included in other types of FACTS-devices (FACTS=Flexible Alternating Current Transmission) than the ones mentioned above.

The high-voltage VSC-converters of today, which are often controlled with PWM-technique (PWM=Pulse Width Modulation), present very large voltage derivatives (dV/dt) in relation to ground on the phase output when the converter is switching. The voltage transient that ensues in this connection, normally lasts during about 1 μs. If the phase output for instance switches from +300 kV to −300 kV, it may consequently ensue a voltage derivative corresponding to about 600 kV/ps. These very large voltage derivatives cause large capacitive currents, especially in lead-throughs and reactors but also in filters, cables, measuring sensors, transformers and other electric equipment connected to the VSC-converter. Such capacitive currents may cause local heating and overheating in said equipment. The currents may also cause local, high electric fields in for instance reactors and transformers, which may result in breakdowns or partial discharges that in the long run may damage the insulation system. Furthermore, the voltage transients cause radio interferences, which may be emitted from the converter itself as well as from the electric equipment connected to the converter. The rapid voltage transients in the phase output may also start different resonances inside or between electric equipment connected to the converter, which may cause heating, high insulation strains or high radio interference levels for the frequencies where resonances occur.

### OBJECT OF THE INVENTION

The object of the present invention is to achieve a VSC-converter according to the preamble of claim 1, in which the problems described above are reduced.

### SUMMARY OF THE INVENTION

According to the invention, said object is achieved by means of a VSC-converter having the features indicated in the characterizing part of claim 1.

Consequently, the solution according to the invention implies that the VSC-converter is provided with one or several capacitive members, through which the phase output of the converter is connected to ground, said capacitive member/members being designed with a capacitance that is adapted for preventing undesiredly large voltage derivatives in relation to ground in the phase output. By arranging a relatively high capacitance in relation to ground in the phase output, the converter is prevented from generating high voltage derivatives in relation to ground, whereby the problems described above can be essentially reduced. The choice of capacitance between the phase output and ground is adapted from case to case and depends i.a. on the voltage and switching frequency for which the converter is dimensioned.

A VSC-converter normally has a very low capacitance in relation to ground in the phase output, which is a prerequisite for allowing the phase output to rapidly change its voltage in relation to ground. The solution according to the invention represents a new thinking within the technical field in question going completely contrary to these prevalent principles for designing a VSC-converter. The capacitance between the phase output and ground will prolong the switching time. For converters controlled with PWM-technique, in applications such as for instance HVDC (High Voltage Direct Current), SVC and Back-to-back, a switching frequency, i.e. the frequency with which the phase output switches, in the order of 1 kHz is often used. Higher as well as lower switching frequencies may however occur. If the capacitive member, or members where appropriate, between the phase output and ground at a switching frequency of for instance 1 kHz is/are dimensioned in such a way that the phase output at typical phase currents switches on for instance 10-20 μs, then this switching time will still only correspond to a fraction of the total PWM-period, wherefore the possibilities to attain a high degree of modulation is not influenced to any appreciable extent in a VSC-converter designed in this manner. The prolonged switching time caused by the capacitance between the phase output and ground does however entail that the voltage derivatives in relation to ground in the phase output are considerably decreased, which reduces the abovementioned problems to a level where they, also in case of a VSC-converter designed for very high voltages, will become considerably easier to handle as compared to the case with a VSC-converter of conventional design.

The solution according to the invention will give particularly large advantages with VSC-converters connected to high-voltage networks, with a network voltage of for instance 130-400 kV, but will also give advantages at lower network voltages, for instance in the order of 10-130 kV.

According to a preferred embodiment of the invention, the converter has an external casing of conductive material, which is connected to ground, said capacitive member/members being connected between the phase output and the casing. Hereby, high current transients in lead-throughs or in electric equipments outside the casing of the converter are avoided. The casing is preferably made of metal, such as for instance of aluminium.

According to another preferred embodiment of the invention, the converter comprises a resonance circuit for recharging said capacitive member/members. By using a resonance circuit for recharging the capacitive member or members that is/are arranged between the phase output and ground, it will also be possible, in addition to a limitation of the voltage derivatives in relation to ground in the phase output, to limit the switching losses in the semiconductor elements of turn-off type in the converter. The resonance circuit preferably is a so-called ARCP-circuit (ARCP=Auxiliary Resonant Commutation Pole), which is adapted to achieve recharging of the capacitive member/members between the phase output and ground in connection with the turn-on of a semiconductor element of the main valves of the converter, so that said semiconductor element can be turned on at low voltage instead of high voltage, whereby the turn-on losses in the semiconductor elements of the main valves are limited. The resonance circuit is also used in connection with turn-off of a semiconductor element of the main valves of the converter when the phase current is so low that the switching time for the voltage in the phase output otherwise would be unreasonably long.

Further preferred embodiments of the inventional VSC-converter will appear from the dependent claims and the subsequent description.

The invention also relates to a plant for transmitting electric power through a direct voltage network for high-voltage direct current (HVDC) according to claim 14.

### BRIEF DESCRIPTION OF THE DRAWING

The invention will in the following be more closely described by means of embodiment examples, with reference to the appended drawing. It is shown in:

FIG. 1 a simplified circuit diagram illustrating a VSC-converter according to a first embodiment of the invention,

FIG. 2 a simplified circuit diagram illustrating a VSC-converter according to a second embodiment of the invention,

FIG. 3 a simplified circuit diagram illustrating a VSC-converter according to a third embodiment of the invention,

FIG. 4 a simplified circuit diagram illustrating a VSC-converter according to a fourth embodiment of the invention, and

FIG. 5 a simplified circuit diagram illustrating a VSC-converter according to a fifth embodiment of the invention.

### DETAILED DESCRIPTION OF PREFERRED EMBODIMENTS

VSC-converters are known in several designs. In all designs, a VSC-converter comprises a number of so-called current valves, each of which comprising a semiconductor element of turn-off type, such as an IGBT (Insulated Gate Bipolar Transistor) or a GTO (Gate Turn-Off Thyristor), and a rectifying member in the form of a diode, normally a so-called free wheeling diode, connected in anti-parallel therewith. Each semiconductor element of turn-off type is normally built up of several series connected, simultaneously controlled semiconductor components of turn-off type, such as several separate IGBT:s or GTO:s. In high-voltage applications a comparatively high number of such semiconductor components is required in order to hold the voltage to be held by each current valve in the blocking state. In the corresponding manner, each rectifying member is built up of several series connected rectifying components. The semiconductor components of turn-off type and the rectifying components are in the current valve arranged in several series connected circuits, each of which circuits comprising i.a. a semiconductor component of turn-off type and a rectifying component connected in anti-parallel therewith.

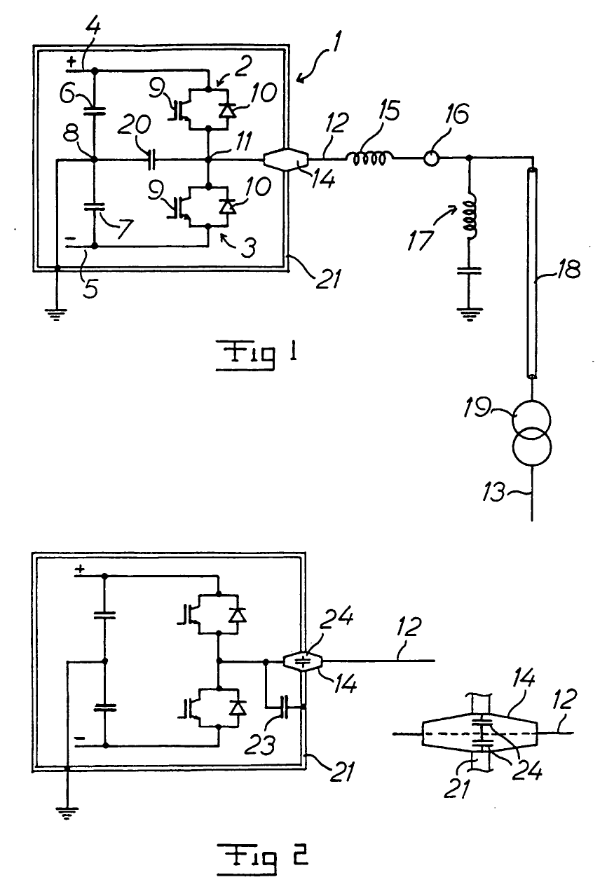

VSC-converters according to a number of alternative embodiments of the invention are illustrated in FIGS. 1-5. In FIGS. 1-5, only the part of the converter that is connected to one phase of an alternating voltage phase line is shown, the number of phases normally being three, but this may also constitute the entire converter when this is connected to a single phase alternating voltage network. The shown part of the converter constitutes a so-called phase leg, and a VSC-converter adapted for instance to a three-phase alternating voltage network comprises three phase legs of the type shown.

The phase leg of the VSC-converter illustrated in FIGS. 1-5 has two current valves 2, 3 connected in series between the two poles 4, 5 of a direct voltage side of the converter. Two series connected capacitors 6, 7, here denominated intermediate link capacitors, are arranged between the two poles 4, 5, and a point 8 between these is normally connected to ground, so as to provide the potentials +U/2 and −U/2, respectively, at the respective pole, U being the voltage between the two poles 4, 5.

In accordance with the above indicated, the respective current valve 2, 3 comprises a semiconductor element 9 of turn-off type, such as an IGBT or a GTO, and a rectifying member 10 in the form of a diode, such as a free wheeling diode, connected in anti-parallel therewith. Although only the symbols for one semiconductor element 9 of turn-off type and one rectifying member 10 are shown in the respective current valve 2, 3, these symbols may in accordance with the above indicated represent several semiconductor components of turn-off type and rectifying components, respectively.

A midpoint 11 of the series connection between the two current valves 2 and 3, which constitutes the phase output of the converter, is connected to an alternating voltage phase line 12. In this manner, said series connection is divided into two equal parts with a current valve 2 and 3, respectively, in each such part.

In FIG. 1, it is illustrated how the phase output 11 of the VSC-converter can be connected to a distribution network or transmission network 13 via electric equipment in the form of a lead-through 14, a reactor 15, a sensor 16 for measuring of current and/or voltage, a filter 17, cables 18 and a transformer 19.

In accordance with the invention, the VSC-converter 1 is provided with means for limitation of the voltage derivatives in relation to ground in the phase output 11, said means comprising one or several capacitive members, through which the phase output 11 is connected to ground, said capacitive member/members being designed with a capacitance that is adapted for preventing undesiredly large voltage derivatives in relation to ground in the phase output. It is preferred that said capacitive member/members is/are arranged inside the external casing 21 of the VSC-converter, which casing is made of an electrically conductive material, preferably metal, and connected to ground. Since the casing 21 consequently constitutes a well-defined grounding point, said capacitive member/members may with advantage be connected to ground through the casing 21.

In the embodiment illustrated in FIG. 1, said means comprises a capacitive member in the form of a capacitor 20, which is connected between the phase output 11 and ground. The capacitive member 20 is here connected to the midpoint 8 of the above mentioned series connection of intermediate link capacitors 6, 7, this midpoint 8 in its turn being connected to ground through the casing 21.

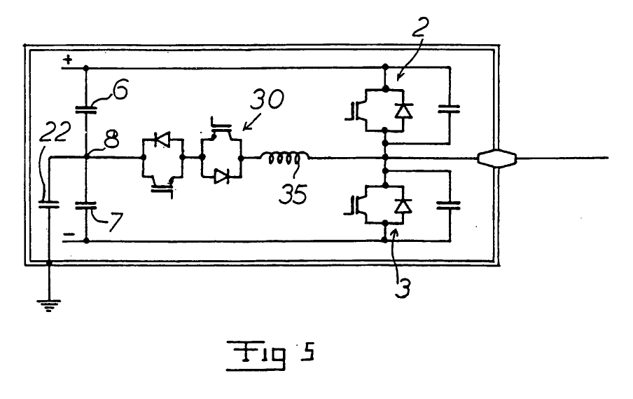

For SVC and Back-to-back applications, where the direct voltage side of the converter is constituted by a so called DC intermediate link, it may sometimes be advantageous not to connect the midpoint 8 of the series connection of intermediate link capacitors 6, 7 to ground. An alternative solution to the arrangement of a capacitive member directly between the phase output 11 and ground may then be, such as illustrated in FIG. 5, to achieve the capacitive connection between the phase output 11 and ground by placing a capacitor 22 between the midpoint 8 of the DC intermediate link and ground.

FIG. 2 illustrates two alternative locations of capacitive members 23, 24 included in the above mentioned means. One of the capacitive members is a capacitor 23 that is connected directly between the phase output 11 and the grounded casing 21 of the converter. In order to avoid that this capacitor has a detrimental influence on the generated alternating voltage, it is required that the capacitor is of low-induction type. The other capacitive member 24 is formed by the lead-through 14 arranged between the alternating voltage phase line 12 and the casing, which lead-through can obtain a capacitance suitable for this purpose by a suitable adaption of its design. The capacitive member 24 is also connected directly between the phase output 11 and the grounded casing 21 of the converter, and must have a low inductance just like the capacitor 23. In FIG. 2, a detail enlargement of the lead-through 14 is also shown, where it is illustrated how the line extending through the lead-through, which line is shown with broken line in the figure, is capacitively connected to the casing 21 of the converter.

The converter according to the invention is suitably provided with a resonance circuit for recharging the capacitive member/members included in the above mentioned means for limitation of the voltage derivatives in relation to ground in the phase output 11. Different types of resonance circuits known per se may here be used. It is however preferred that the resonance circuit is a so-called ARCP-circuit (ARCP=Auxiliary Resonant Commutation Pole), which has proven to be very suitable for the object here in question.

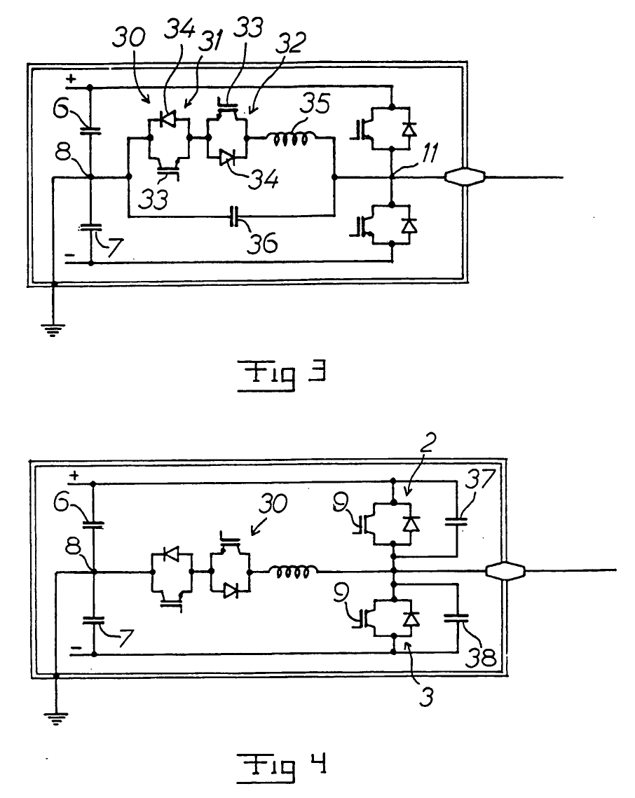

A preferred embodiment of such an ARCP-circuit is shown in FIGS. 3 and 4. The ARCP-circuit here comprises an auxiliary valve 30 comprising a set of two series connected auxiliary valve circuits 31, 32, each of which comprising a semiconductor component 33 of turn-off type, such as an IGBT or a GTO, and a rectifying component 34 in the form of a diode, such as a free wheeling diode, connected in anti-parallel therewith. The semiconductor elements 33 of turn-off type of the two auxiliary valve circuits 31, 32 are arranged in opposite polarity in relation to each other. The ARCP-circuit further comprises at least one inductor 35 connected in series with said auxiliary valve 30. The ARCP-circuit may also comprise several series connected sets of auxiliary valve circuits if considered appropriate, and may of course also as to the rest have another design than shown in FIGS. 3 and 4.

The function of an ARCP-circuit of the type illustrated in FIGS. 3 and 4 is well known to the person skilled in the art and is for instance described in U.S. Pat. No. 5,047,913, and will therefore not be described more closely here.

In the embodiment illustrated in FIG. 3, said means for limitation of the voltage derivatives in relation to ground in the phase output 11 comprises a capacitive member in the form of a capacitor 36, which is connected between the phase output 11 and ground and connected in parallel with the auxiliary valve 30 and the inductor 35 of the resonance circuit.

In the embodiment illustrated in FIG. 4, said means for limitation of the voltage derivatives in relation to ground in the phase output 11 comprises a capacitive member in the form of capacitors 37, 38, which are connected in series with the auxiliary valve 30 and the inductor 35 and in parallel with a respective current valve 2, 3, which current valves also often being denominated main valves. The respective capacitor 37, 38 is here connected to ground through one of the intermediate link capacitors 6, 7 and the grounded midpoint 8 between the intermediate link capacitors 6, 7. These capacitors 37, 38 also constitute so called snubber capacitors, which decrease the turn-off losses in connection with turn-off of the semiconductor elements 9 of the current valves.

The auxiliary valve 30 and inductor 35 of the resonance circuit may in co-operation with the capacitor 36 (FIG. 3) and the snubber capacitors 37 and 38 (FIG. 4), respectively, in a manner known per se make possible a turn-on of the semiconductor elements 9 of the current valves at essentially zero voltage or at least a very low voltage across the respective semiconductor element 9 that is being turned on. This function is denominated “soft switching” and implies that the turn-on losses of the current valves 2, 3 can be kept very low.

The choice of capacitance of the capacitive members 20, 22, 23, 24, 36, 37, 38 arranged between the phase output 11 and ground is adapted from case to case and depends i.a. of the voltage and switching frequency for which the converter is dimensioned. In all cases, it is however required that the respective capacitive member has a capacitance that is considerably lower than the capacitance of the intermediate link capacitors 6, 7.

The resonance frequency of the resonance circuit is suitably chosen such that the resonance period will amount to about 20-40 μs, which makes possible a recharging of the capacitive members 36, 37, 38 from one of the pole voltages to the other in about 10-20 μs.

The inventional VSC-converter is preferably controlled with PWM-technique, in which case the resonant circuit and said capacitive members should be so adapted that the recharging time for said capacitive members corresponds to 1-10% of the PWM-period and preferably to 1-5% of the PWM-period.

The function of a VSC-converter of the type illustrated in FIGS. 1-5 is well known to a person skilled in the art and will therefore not be more closely described here.

The inventional VSC-converter is preferably designed for network voltages of 130-400 kV, but may also be designed for voltages for instance in the order of 10-130 kV.

The inventional VSC-converter may with advantage be included in a plant for transmitting electric power through a direct voltage network for high-voltage direct current (HVDC), for instance in order to transmit the electric power from the direct voltage network to an alternating voltage network. In this case, two direct voltage cables are connected to the direct voltage side of the converter, a first direct voltage cable being connected to one pole 4 of the converter and a second direct voltage cable being connected to the other pole 5 of the converter.

The means for limitation of the voltage derivatives in relation to ground in the phase output may comprise any of the capacitive members 20, 22, 23, 24, 36 or 37 and 38 illustrated in FIG. 5, or arbitrary combinations of these members. An advantage with making the means comprising several capacitive members of different types is that each individual member may be adapted for instance for limitation of radio interferences of a certain frequency level. Said means included in the invention may of course also comprise capacitive members arranged between the phase output 11 and ground in any other way than illustrated in FIGS. 1-5.

It is emphasized that the invention is in no way limited to VSC-converters having only two series connected current valves per phase leg, but is also intended to embrace converters having a larger number of current valves and where the current valves are arranged in another way than shown in FIGS. 1-5. It is also emphasized that the converter according to the invention may have its direct voltage side designed in another way than shown in FIGS. 1-5, and for instance may comprise more than two series connected intermediate link capacitors.

The invention is of course neither as to the rest in any way restricted to the preferred embodiments described above, on the contrary many possibilities to modifications thereof should be apparent to a person skilled in the art without departing from the basic idea of the invention as defined in the appended claims.

1. A VSC-converter for converting high-voltage direct voltage into alternating voltage and vice versa, which comprises a series connection of at least two current valves (2, 3) arranged between two poles (4, 5), a positive and a negative, of a direct voltage side of the converter, each of which current valves comprising a semiconductor element (9) of turn-off type and a rectifying member (10) connected in anti-parallel therewith, an alternating voltage phase link; (12) being connected to a midpoint (11), denominated phase output, of the series connection between two current valves while dividing the series connection into two equal parts, characterized in that the converter is provided with means for limitation of the voltage derivatives in relation to ground in the phase output (11), said means comprising one or several capacitive members (20, 22, 23, 24, 36, 37, 38), through which the phase output (11) is connected to ground, said capacitive member/members (20, 22, 23, 24, 36, 37, 38) being designed with a capacitance that is adapted for preventing undesiredly large voltage derivatives in relation to ground in the phase output (11).

2. A VSC-converter according to claim 1, the converter having a casing (21) of conductive material, preferably of metal, which is connected to ground, characterized in that said capacitive member/members (20, 22, 23, 24, 36, 37, 38) is/are connected between the phase output (11) and the casing (21).

3. A VSC-converter according to claim 2, characterized in that at least one of said capacitive members is a low-induction capacitor (23), which is connected directly between the phase output (11) and the casing (21).

4. A VSC-converter according to claim 2 or 3, the alternating voltage phase line (12) being arranged to extend through the casing (21) via a lead-through (14) arranged in the casing, characterized in that the lead-through (14) constitutes one of said capacitive members (24).

5. A VSC-converter according to any of the preceding claims, characterized in that the converter comprises a resonance circuit for recharging said capacitive member/members (36; 37, 38).

6. A VSC-converter according to claim 5, the converter having a series connection of at least two intermediate link capacitors (6, 7) on its direct voltage side between said poles (4, 5), characterized in that the resonance circuit is an ARCP-circuit (ARCP=Auxiliary Resonant Commutation Pole).

7. A VSC-converter according to claim 6, characterized in that the ARCP-circuit comprises an auxiliary valve (30) comprising at least one set of two series connected auxiliary valve circuits (31, 32), each of which comprising a semiconductor component (33) of turn-off type and a rectifying component (34) connected in anti-parallel therewith, the semiconductor components (33) of turn-off type of the two auxiliary valve circuits being arranged in opposite polarity in relation to each other, and that the ARCP-circuit further comprises an inductor (35) connected in series with said auxiliary valve ( ).

8. A VSC-converter according to claim 7, characterized in that at least one of said capacitive members is a capacitor (36) that is connected in parallel with the series connection of auxiliary valve (30) and inductor (35) included in the ARCP-circuit.

9. A VSC-converter according to any of claims 7-8, characterized in that at least some of said capacitive members are capacitors (37, 38) that are connected in series with the series connection of auxiliary valve (30) and inductor (35) included in the ARCP-circuit and in parallel with a respective current valve (2, 3).

10. A VSC-converter according to any of the preceding claims, the converter having a series connection of at least two intermediate link capacitors (6, 7) on its direct voltage side between said poles (4, 5), characterized in that at least one of said capacitive members is a capacitor (20) that is connected between the phase output (11) and the midpoint (8) of said series connection of intermediate link capacitors (6, 7), the midpoint (8) of said series connection of intermediate link capacitors (6, 7) being connected to ground.

11. A VSC-converter according to any of claims 1-9, the converter having a series connection of at least two intermediate link capacitors (6, 7) on its direct voltage side between said poles (4, 5), characterized in that at least one of said capacitive members is a capacitor (22) that is connected between the midpoint (8) of said series connection of intermediate link capacitors (6, 7) and ground.

12. A VSC-converter according to any of the preceding claims, characterized in that the converter is controlled with PWM-technique.

13. A VSC-converter according to claim 12, characterized in that the resonance circuit and said capacitive member/members are adapted in such a way that the recharge time for said capacitive member/members corresponds to 1-10% of the PWM-period and preferably 1-5% of the PWM-period.

14. A plant for transmitting electric power through a direct voltage network for high-voltage direct current (HVDC), characterized in that the plant comprises a VSC-converter according to any of claims 1-13 for converting the electric power from the direct voltage network to an alternating voltage network, one (4) of the poles of the converter being connected to a first direct voltage cable included in the direct voltage network and the other pole (5) of the converter being connected to a second direct voltage cable included in the direct voltage network.
